(19) United States
(12) Patent Application Publication
(10) Pub. No.: US 2002/0188038 A1
(43) Pub. Date: Dec. 12, 2002

(54) Ink composition using alkyd-stabilized acrylic dispersions

(76) Inventors: Joseph L. McJunkins, Avon Lake, OH (US); Matthew V. Croyle, Shaker Heights, OH (US); Madhukar Rao, Twinsburg, OH (US); Richard F. Tomko, North Olmsted, OH (US)

Correspondence Address: Vivien Y. Tsang, Esq., The Sherwin-Williams Company - Legal Dept., 101 Prospect Avenue, N.W., Cleveland, OH, 44115, US

(21) Appl. No.: 10/127,053

(22) Filed: Apr. 19, 2002

Related U.S. Application Data
(60) Provisional application No. 60/285,369, filed on Apr. 20, 2001.

(51) Int. Cl. C03C 17/00; C09D 5/00

(52) U.S. Cl. 523/160; 523/161

(57) ABSTRACT

An ink composition comprising a pigment or pigment dispersion; and an alkyd-stabilized acrylic dispersion having a non-volatile materials content of greater than 70%; and an ink solvent. The alkyd-stabilized acrylic dispersion comprises an alkyd resin; at least one acrylic monomer suitable for free radical addition polymerization, wherein at least one acrylic monomer is hydroxy-functional; and a chain transfer agent.

### CROSS-REFERENCE TO RELATED APPLICATION

This application claims the benefit of U.S. Provisional Application No. 60/285,369 filed Apr. 20, 2001.

### FIELD OF THE INVENTION

This invention relates to an ink composition utilizing an alkyd-stabilized acrylic dispersion having a nonvolatile materials content of greater than 70%.

### BACKGROUND OF THE INVENTION

Liquid inks are widely used in a variety of printing processes, for example, offset, rotogravure, electrographic printing, ink jet, etc. Many of the desired characteristics of liquid inks are the same for each of the respective processes, even though the final ink formulations may be substantially different. Printing inks generally must meet a number of performance characteristics that include both requirements related to the printing process, such as suitable consistency and tack for sharp, clean images, suitable drying characteristics, and other requirements related to the printed image, such as gloss, chemical resistance, durability, color, etc. In general, inks include one or more materials such as pigments, vegetable oils or fatty acids, resins, and polymers that contribute to the end product properties, and may include other components such as organic solvents, water, rheology modifiers, and so on that may affect ink color, tack, and drying characteristics. It is necessary to ensure good wetting of the pigments by choosing appropriate binder compositions, by special additives, or by pretreating the pigments.

Pontes et al., U.S. Pat. No. 5,100,469, disclose an ink composition comprising a colorant, a liquid carrier, and an additive selected from the group consisting of mesoerythritol and salts thereof, and RC(CH2OH)3 and salts thereof. Pontes et al. further disclose the composition may comprise from about 1.0% to about 5.0%, by weight, humectant, and that suitable humectants include glycerol, thiodiglycols, ethylene glycol, diethylene glycol and 2-pyrrolidone. Pontes et al. teach colorants may include direct dyes, acid dyes, reactive dyes and polymeric dyes.

Hotomi et al., U.S. Pat. No. 5,376,169, disclose a recording solution for ink jetting comprising pigment, resin, an additive selected from the group consisting of alginates and bomeols, and at least 55%, by weight, of a non-aqueous solvent. Hotomi et al. further teach the non-aqueous solvent may be selected from monoethylene glycol, monobutyl ether, diethylene glycol monobutyl ether, triethylene glycol monobutyl ether, monopropylene glycol monobutyl ether, dipropylene glycol monobutyl ether, tripropyl monobutyl ether, butyl cellosolve and 2-pyrrolidone. The recording solution of Hotomi et al. may further comprise from 7% to 45%, by weight, of a compound selected from water, dithioethanol, formamide, glycerin, ethylene carbonate and methane sulfonic acid.

Gundlach et al., U.S. Pat. No. 5,531,815, disclose ink compositions comprising a betaine zwitterionic base, a quasisurfactant penetrant and, optionally, solvents such as n-ethylpyrrolidione, thiodiethanol, ethylene glycol, trimethylol propane, sulfolane and glycerine.

Gundlach et al., U.S. Pat. No. 5,534,050, disclose ink compositions comprising an acetylenic polyalkylene oxide and a quasisurfactant penetrant. Gundlach et al. disclose solvents such as cyclohexyl pyrrolidione and co-solvents such as n-methylpyrrolidinone, thiodiethanol, ethylene glycol, trimethylol propane, sulfolane, and glycerine.

Nagai et al., U.S. Pat. No. 5,882,390, disclose a recording ink composition comprising a colorant which includes at least one phthalocyanine compound, a dispersant and/or surfactant, water and a humectant. Nagai et al. further disclose that humectants include water-soluble organic solvents such as diethylene glycol, thiodiethanol, polyethylene glycol, glycerol, N-methyl-2-pyrrolidinone, N-hydroxy-2-pyrrolidone, 2-pyrrolidone and 1,3-dimethylimidazolidinone.

Nagai et al., U.S. Pat. No. 5,879,439, disclose a recording ink composition comprising a colorant comprising a pigment and a polymeric dye, a dispersant and/or surfactant, water, and a water-soluble organic solvent such as diethylene glycol, thiodiethanol, polyethylene glycol, triethylene glycol, glycerol, 1,2,6-hexanetriol, 1,2,4-butanetriol, 3-methylpentane-1,3,5,-triol, 1,5-pentanediol, N-methyl-2-pyrrolidone, N-hydroxy ethyl-2-pyrrolidone, 2-pyrrolidone and 1,3-dimethylimidazolidinone.

Nagai et al., U.S. Pat. No. 5,810,915 disclose an aqueous ink composition including a dye component containing a water-soluble xanthene dye or a water-soluble phthalocyanine dye. Nagai et al. teach that the composition may further comprise water-soluble organic solvents such as diethylene glycol, thiodiethanol, polyethylene glycol, triethylene glycol, glycerol, 1,2,6-hexanetriol, 1,2,4-butanetriol, 3-methylpentane-1,3,5-triol, 1 ,5-pentanediol, N-methyl-2-pyrrolidone, N-hydroxy-ethyl-2-pyrrolidone, 2-pyrrolidone and 1,3-dimethylimidazolidinone.

It has now been found that an ink composition utilizing an alkyd-stabilized acrylic dispersion, in combination with a pigment dispersion, provide for inks having excellent print quality. Due to the versatility of the alkyd-stabilized acrylic dispersions of this invention, the number of ingredients in the ink composition can be minimized. The inks of the present invention possess advantages such as stability, good color acceptance, and have good adhesion, dry time, set time, set-to-touch time, gloss properties, and reduced process time.

### SUMMARY OF THE INVENTION

An ink composition comprising:

a. a pigment or pigment dispersion; and

b. an alkyd-stabilized acrylic dispersion having a non-volatile materials content of greater than 70%; and

c. an ink solvent.

The alkyd-stabilized acrylic dispersion comprises (a) an alkyd resin; (b) at least one acrylic monomer suitable for free radical addition polymerization, wherein at least one acrylic monomer is hydroxy-functional; and (c) a chain transfer agent.

### DETAILED DESCRIPTION OF THE INVENTION

The present invention is an ink composition which comprises an alkyd-stabilized acrylic dispersion vehicle having a non-volatile materials content of greater than 70%, a pigment or a pigment dispersion, and an ink solvent. In the present invention, the alkyd-stabilized acrylic dispersion comprises an alkyd resin that has a z-average molecular weight (Mz) greater than 20,000, a non-volatile materials content greater than about 70%, a Brookfield viscosity of >100 centipoise (cps) (LVT#3 spindle @ 12 rpm and 25° C.), an oil length in the range of about 40% to about 70%, and an acid value of less than 10. The alkyd can be either drying, or non-drying, and is derived from natural oil.

The alkyd resin used for the preparation of the alkyd-stabilized acrylic dispersion is derived from a triglyceride oil which can be selected from the group consisting of linseed oil, soya oil, coconut oil, cottonseed oil, peanut oil, canola oil, corn oil, safflower oil, sunflower oil, dehydrated castor oil, fish oil, perilla, lard, walnut oil, tung oil and mixtures thereof.

To form the alkyd, the triglyceride oil is first reacted via an acidolysis reaction with a trifunctional carboxylic acid such as trimelletic acid, trimesic acid, 1,3,5-pentane tricarboxylic acid, citric acid or a trifunctional anhydride such as trimelletic anhydride, pyromelletic anhydride, or mixtures of such acids and/or anhydrides.

The intermediate from the acidolysis step is further reacted with a trifunctional alcohol selected from the group consisting of trimethylol propane, trimethylol ethane, glycerine, tris hydroxyethyl isocyanurate, and mixtures thereof, either alone or in combination with a difunctional alcohol selected from the group consisting of ethylene glycol, propylene glycol, cyclohexane dimethanol, and mixtures thereof. Additionally, dimethylol propionic acid can be used in combination with the trifunctional alcohol. Trifunctional alcohols are particularly preferred due to the degree of branching they allow. Difunctional alcohols, if used, are preferably used as a minor component in combination with trifunctional alcohols. Depending on the desired molecular weight and viscosity, a portion of monofunctional alcohol, or monobasic acid such as soya fatty acid, linseed oil fatty acid or crotonic acid, up to about 20% by weight of the total alkyd can be added with the multifunctional alcohol to control molecular weight and act as a chain stopper.

The order of reactions, i.e. acidolysis with a trifunctional acid or anhydride, followed by esterification with a trifunctional alcohol, is critical to the formation of the high molecular weight, low viscosity alkyd of this invention.

The amounts of oil, acid and alcohol used should be such that the resulting alkyd has a high degree of branching, a z-average molecular weight, M_{z}, greater than or equal to about 20,000, and an oil length of between about 40% and 70%.

In the first step of the acidolysis, the proportion of triglyceride oil to acid or anhydride should be such that the moles of carboxylic acid equivalents contributed from the acid or anhydride is approximately 2 to 3 times the moles of carboxylic ester equivalents contributed by the oil.

For example, trimelletic anhydride has a carboxylic acid functionality of about 3 whereas soya oil has a carboxylic ester functionality of about 1. Thus, a molar ratio of acid:oil of 1:1 would result in a molar functionality ratio of acid:ester of about 3:1. To achieve the molar acid:ester functionality ratio in the range of 2:1 to 3:1, generally the ratio of moles acid:oil should be approximately 1:1.75 to 1:1.

The oil and the acid should be charged into a reactor equipped with an inert gas blanket and a mechanical stirrer. The two reactants should be heated to a temperature greater than or equal to about 450° F., preferably to a temperature of about 480° F. This temperature should be held for a sufficient time period to allow the complete reaction of the two reactants. Typically, at this temperature, the reaction takes approximately one hour. If desired, a reaction catalyst such as lithium hydroxide monohydrate, barium hydroxide, or di-butyl tin oxide can be added in an amount of approximately 0.02% by weight of oil. The intermediate produced by this acidolysis reaction should be cooled to about 320° F. in preparation for the second step of the reaction.

In the second step of the reaction, the amount of multifunctional alcohol should be such that the moles of hydroxyl equivalents contributed by the alcohol is in excess over the moles of carboxylic acid equivalents contributed by the acid or anhydride. Thus, for a trifunctional alcohol such as trimethylol ethane, and a trifunctional acid such as trimelletic anhydride, the molar ratio of alcohol: anhydride should be about 1:1 to about 1.5:1. The alcohol is preferably added in bulk to the reaction vessel containing the product of the acidolysis reaction, although the alcohol can be added in two or more charging stages. The temperature is raised to between about 425° F. and 500° F. and these reaction conditions are maintained for so long as necessary to bring the acid value of the solution below about 15, preferably below about 10. During this stage of the reaction, some additional azeotropic solvent such as xylene can be added to the vessel to facilitate the removal of water from the reaction solution. The xylene is removed at the end of the reaction.

As stated above, the z-average molecular weight, M_{z}, of the resulting alkyd should be greater than or equal to about 20,000, the oil length should be between about 40% and 70%. These alkyds have non-volatile materials (NVM) contents greater than 70%. These alkyds can also be made via conventional alcoholysis, or fatty-acid esterification, but the preferred approach is acidolysis, which results in high solids, low viscosity alkyds.

When preparing alkyd-stabilized acrylic dispersions using the alkyd above, the monomers should be selected from monomers which would produce a polymer via the free radical addition reaction mechanism which is predominantly insoluble in the alkyd medium. It is highly preferred that at least one of the monomers contain hydroxyl functionality. Most preferably, between about 5% and 35% by weight of the monomers comprises hydroxyl functional monomers, especially hydroxy ethyl acrylate and methacrylate, and hydroxy propyl acrylate and methacrylate. Other suitable monomers for preparing the alkyd-stabilized acrylic dispersion can be selected from the group consisting of acrylonitrile, methacrylonitrile, acrylic acid, methacrylic acid, itaconic acid, and esters of these acids, methyl acrylate and methacrylate, ethyl acrylate and methacrylate, butyl acrylate and methacrylate, lauryl acrylate and methacrylate, and the like, trimethylol propane triacrylate and trimethacrylate, hexanediol diacrylate, acrylamide, methacrylamide, vinyl chloride, vinylidene chloride, styrene, divinyl benzene, vinyl toluene, vinyl naphthalene, and mixtures thereof. In addition to pure monomers, preformed polymers and polymeric intermediates can be included in the reaction charge.

To prepare the alkyd-stabilized acrylic dispersions of this invention, the alkyd is used as the polymerization medium for the monomers. The alkyd medium can be diluted with a natural oil such as linseed oil, soya oil, coconut oil, cottonseed oil, peanut oil, canola oil, corn oil, safflower oil, sunflower oil, dehydrated castor oil, fish oil, perilla, lard, walnut oil, tung oil and mixtures thereof.

The total amount of alkyd contained in the reaction vessel, including any alkyd which may be added with the monomers, can comprise between about 25% to about 99%, preferably from about 30% to about 60%, most preferably between about 40% to about 55%, by weight of the combined total alkyd and total monomers. The free radical addition monomers should, after completely added to the reaction vessel, account for approximately 1% to about 75%, preferably between about 40% to about 70%, by weight of the combined total alkyd and total monomers, most preferably between about 45% to about 60%. A chain transfer agent such as methyl mercaptopropionate or 2-mercapto ethanol must also be added to the vessel in an amount from about 0.1% to about 6.0% by weight of the total monomers. The chain transfer agent is preferably present from about 0.1% to about 1.0% by weight of the total monomers. An initiator selected from the group consisting of t-butyl peroctoate, t-amyl peroctoate, cumene hydroperoxide, and t-butyl perbenzoate is also preferably added.

All free radical addition reactants are preferably added via dropwise addition over a period of time to the alkyd dispersing medium. The monomers can be added pure, or, in a preferred embodiment, the monomers can be dispersed in an amount of the alkyd of this invention prior to addition to the dispersing medium. The amount of alkyd used for such a dispersion should be included in the calculation of the overall amount of alkyd present in the reaction vessel.

The temperature of the solution in the reaction vessel should be maintained between about 200° F. and 250° F. for the entire period that the monomers are being added. Upon completion of the monomer addition, a chaser composition comprising cumene hydroperoxide and vanadium octoate is added over a period of about 90 minutes. Upon completion of the chase composition, the temperature should be maintained between 200° F. and 250° F. for approximately one hour. At the end of that hour, the heat is removed and the contents of the vessel are filtered. The resulting alkyd-stabilized acrylic dispersion has a non-volatile materials content of greater than 70%, and preferably greater than 85%, and more preferably greater than 95%, and exhibit excellent air dry times using conventional metallic drier compounds.

The ink compositions of this invention utilize the alkyd-stabilized acrylic dispersions described above with one or more pigments or pigment dispersions and an ink solvent. The number and kinds of pigments or pigment dispersions will depend on the kind of ink being formulated. In practice, pigment particles are deagglomerated or dispersed in aqueous media to achieve greater uniformity in print quality of the ink. Any means for dispersing the pigment particles that is compatible with the remaining ink components may be employed in the practice of this invention. Examples of such pigments that may be employed include Pigment Yellow 128 and Pigment Blue 153, which are available from Ciba Specialty Chemicals, Corporation, High Point, N.C.; and Fuji BBL Red and Fuji BBL Magenta, which are available from Fuji Pigment Company, Japan.

At least one aqueous pigment dispersion is employed in the practice of this invention. It is contemplated that a commercially-available concentrated aqueous pigment dispersion is employed in the practice of the invention. Examples of such pigment dispersions include Flush Red 2B color, commercially available from Hercules Pigment, Mubai, India. It is noted that the water present in such commercially-available concentrated aqueous pigment dispersions forms part of the ink composition. The pigment dispersion may represent up to about 60 weight percent of the ink composition.

The ink composition of this invention also contains a high boiling ink solvent such as EXXPRINT 588, which is an aliphatic ink solvent commercially available from Exxon Chemical Company, Houston, Tex. Preferably, the boiling point of the ink solvent should be at least 180° C. (and preferably at least 240° C.); however, ink solvents of widely varying boiling points, depending on the particular printing application, may be used in combination with the components of the ink vehicle composition. Other suitable ink solvents include, without limitation, alcohols, esters, ketones, aromatic naphthas, petroleum distillates and the like.

The ink compositions of this invention can also include one or more solvent carriers. The solvent carrier can be any of a number of organic solvents known to be useful with pigmented inks or pigment dispersions. Selection of a suitable solvent carrier depends on the requirements of the specific application, such as desired surface tension and viscosity, the selected pigment dispersion, drying time of the pigmented ink, and type of substrate onto which the ink will be printed. Suitable solvents can be selected from the group consisting of alcohols, esters, aliphatic or aromatic hydrocarbons, and the like.

It will be appreciated by the skilled artisan that other additives known in the art may be included in the ink compositions of the invention, so long as such additives do not significantly detract from the benefits of the present invention. Illustrative examples of these include, without limitation, surfactants, wetting agents, waxes, emulsifying agents and dispersing agents, defoamers, antioxidants, UV absorbers, driers (e.g., for formulations containing vegetable oils), flow agents, and other rheology modifiers, gloss enhancers, and anti-settling agents. The ink composition may further comprise additives such as humectants, biocides, fungicides, bactericides, penetrants, surfactants, anti-coagulation agents, buffers, anti-curling agents, chelating agents, and anti-bleed agents. When included, additives are typically included in amounts of at least about 0.001% of the ink composition, and may be included in an amount 7% by weight or more of the ink composition.

Suitable humectants include ethylene glycol, diethylene glycol, and propylene glycol. Suitable chelating agents include sodium ethylene diamine tetraacetate, sodium nitrilotriacetate, sodium hydroxyethyl ethylene diamine triacetate and sodium diethylene triamine pentaacetate. Suitable biocides include methyl-isothiazolin-one, chloro-methyl-isothiazolin-one, sodium dehydroacetate, sodium sorbate, sodium 2-pyridinethiol-1-oxide, sodium benzoate and sodium pentachlorophenol. A preferred anti-bleed agent is 2-(2-butoxyethoxy)ethanol.

Suitable penetrants include 1,2-alkyl diols having from about 4 to about 6 carbon atoms and straight chain 1-hydroxy alkanols having from about 1 to about 5 carbon atoms. Preferred 1,2-alkyl diols penetrants include 1,2-pentanediol and 1,2-hexanediol, while 1-propanol is a preferred 1-hydroxyalkanol penetrant. In one embodiment the ink composition comprises from about 0.1% to about 10% of a penetrant comprising a straight chain 1-hydroxy-alkanol having from about 1 to about 5 carbon atoms, preferably the penetrant is 1-propanol.

The ink compositions may optionally comprise surfactants to modify the surface tension of the ink and to control the penetration of the ink into the paper. Suitable surfactants include nonionic, amphoteric and ionic surfactants.

The ink compositions of the present invention are manufactured using any suitable techniques. In one embodiment, the ink is prepared by mixing pigment or pigment dispersion, alkyd-stabilized acrylic dispersion, and ink solvent together to form a concentrate. Additional components may be added to give the desired ink properties.

The invention is illustrated by the following examples. The examples are merely illustrative and do not in any way limit the scope of the invention as described and claimed. All parts are parts by weight unless otherwise noted.

### EXAMPLE ONE

Preparation of Alkyd

Charge 14,925 grams of alkali refined soya oil and 2240 grams of trimelletic anhydride to a reactor equipped with inert gas and a mechanical stirrer. Heat the contents to 480° F. and hold for about one hour. Cool to about 350° F. and add 1704 grams of trimethylol ethane and 368 grams of xylene. Heat the contents to about 480° F. and hold for an Acid Value less than or equal to 10. Continue to hold the contents at this temperature until residual xylene is stripped off. The resulting alkyd has an non-volatile materials content of approximately 99.5%, a Brookfield viscosity of 1000-1750 centipoise, using an LVT spindle #3 at 12 rpm and 25° C., an acid value of about 10, an Mz of about 102,000, an oil length of about 79, and a hydroxyl number of about 47.

### EXAMPLE TWO

Preparation of Alkyd Stabilized Acrylic Dispersion

Charge 366 grams of the alkyd prepared according to Example One and 500 grams of soybean oil to a reactor equipped with a mechanical stirrer. Heat to 230° F. Begin a three hour dropwise addition of Solutions #1 and #2 below:

Solution #1: 545 grams of alkyd prepared according to Example One, 975 grams of methyl methacrylate, 487.5 grams of hydroxy ethyl acrylate, and 10 grams of 2-mercapto ethanol (chain transfer agent).

Solution #2: 100 grams of soybean oil and 11 grams of t-butyl peroctoate (initiator).

Upon completion of the addition of Solutions #1 and #2 hold for one hour at 230° F., and charge with approximately four (4) drops of vanadium octoate. Begin a three hour addition of a “chase” comprising 100 grams of soybean oil, and 35 grams of cumene hydroperoxide. Hold the temperature at 230° C. for approximately one hour after the chase has been completely added.

The resulting alkyd-stabilized acrylic dispersion—has a NVM of approximately 98% and a viscosity of approximately 8000 centipoise using the Brookfield LVT viscometer with Spindle #3 at 12rpm and 25° C.

### EXAMPLE THREE

Preparation of Ink Composition

A paste ink composition according to the present invention can be prepared by mixing the above components using a suitable method. Preferably, the alkyd-stabilized acrylic dispersion and the ink solvent are first mixed together by a suitable mixer or mill to prepare a homogeneous dispersion. A Fuji BBL 2097 Red pigment is added at 3000 rpm at 140° F. to 160° F. The composition is let down with driers and the high boiling solvent, such as EXXPRINT 588, is added thereto. All other additives are added at 3000 rpm.

Example: Paste Ink Composition

| % by Weight | |
|---|---|
| (based on total solids) | Component |
| 42% | 100% solids soya alkyd-modified acrylic |
| | dispersion |
| 52% | Flush Red 2B color, predispersed |
| | (commercially available from Hercules |
| | Pigment) |
| 0.8% | Manganese drier, 12% |
| 0.2% | Cobalt drier, 12% |
| 5% | EXXPRINT 588 |

Premix the vehicle and flush color at 3000 (±250) rpm at 140°-160° F. Run to a desired grind and let down with driers, and any additional oil or additives at 3000 rpm.

The components should be blended in appropriate ratios for desired performance based on specific applications. The ink composition generally comprises from about 20% to about 60%, more preferably about 35% to about 50% by weight, alkyd-stabilized acrylic resin, from about 40% to about 60%, preferably from about 45% to about 55% by weight, of a pigment dispersion, and from about 2% to about 25%, preferably from about 4% to about 6%, of an ink solvent. The weight ratio of the alkyd-stabilized acrylic dispersion to the pigment dispersion is generally from about 45:55 to about 55:45, and more preferably about 50:50.

1. An ink composition comprising:
a. a pigment or pigment dispersion;
b. an alkyd-stabilized acrylic dispersion having a non-volatile materials content of greater than 70%; and
c. an ink solvent.

2. The ink composition of claim 1, wherein the alkyd-stabilized acrylic dispersion comprises:
a. an alkyd resin;
b. at least one acrylic monomer suitable for free radical addition polymerization, wherein at least one of the monomers is hydroxy-functional; and
c. a chain transfer agent..

3. An ink composition comprising:
a. between about 40% to about 60% of a pigment or pigment dispersion;
b. between about 20% to about 60% of an alkyd-stabilized acrylic dispersion having a non-volatile materials content of greater than 70%; and
c. between about 2% to about 25% of an ink solvent.

4. The ink composition of claim 1, wherein the alkyd-stabilized acrylic dispersion comprises:
a. between about 25% to about 99% alkyd resin;
b. between about 1 to about 75% of at least one acrylic monomer, wherein at least one acrylic monomer is hydroxy-functional; and
c. between about 0.1 to about 6% of a chain transfer agent.

5. The ink composition of claim 4, wherein the hydroxy-functional acrylic monomer is present at between about 5% and 35% of the total monomers.

6. The ink composition of claim 2, wherein the alkyd resin has a z-average molecular weight greater than 20,000 and a non-volatile materials content greater than about 70%, an oil length in the range of about 40% to about 85%, an acid value of less than 10, and wherein the alkyd comprises drying, or non-drying natural oil.

7. The ink composition of claim 1, wherein the alkyd-stabilized acrylic resin has a non-volatile materials content of greater than about 70% and a viscosity of from 100-10,000 centipoise as measured using the Brookfield LVT viscometer with #3 spindle at 12 rpm and 25° C.

8. The ink composition of claim 2, wherein the alkyd-stabilized acrylic dispersion further comprises a natural or synthetic oil.

9. The ink composition of claim 1, wherein the pigment or pigment dispersion is from about 40% to about 60% of the total weight of the ink composition, the alkyd-stabilized acrylic resin is from about 20% to about 60% by weight of the total ink composition, and the ink solvent is from about 2% to about 25% by weight of the total ink composition.

10. The ink composition of claim 1, wherein the alkyd is derived from a triglyceride oil.

11. The ink composition of claim 10, wherein the triglyceride oil is selected from the group consisting of linseed oil, soya oil, coconut oil, cottonseed oil, peanut oil, canola oil, corn oil, safflower oil, sunflower oil, dehydrated castor oil, fish oil, perilla, lard, walnut oil, tung oil and mixtures thereof.

12. The ink composition of claim 1, wherein the solvent can be selected from the group consisting of alcohols, esters, ketones, petroleum distillates, and aromatic naphthas.

13. The ink composition of claim 1, where the alkyd-stabilized acrylic dispersion has a non-volatile materials content of greater than 85%.
